(19) United States
(12) Patent Application Publication
(10) Pub. No.: US 2007/0136177 A1
(43) Pub. Date: Jun. 14, 2007

(54) Registry for on-line auction system

(75) Inventors: Jean C. Reeth, San Jose, CA (US); Corey Chandler, San Mateo, CA (US); Erik Rannala, San Francisco, CA (US); Suzanne C. Scott, Menlo Park, CA (US); Renee Gentry VonBergen, San Jose, CA (US)

Correspondence Address: SCHWEGMAN, LUNDBERG, WOESSNER & KLUTH/EBAY, P.O. BOX 2938, MINNEAPOLIS, MN, 55402, US

(73) Assignee: eBay Inc.

(21) Appl. No.: 11/298,404

(22) Filed: Dec. 9, 2005

(51) Int. Cl. G06Q 40/00

(52) U.S. Cl. 705/37

(57) ABSTRACT

A method and a system to conduct an on-line auction within a network-based commerce system with respect to offerings on a registry. The method includes in particular receiving offer data pertaining to offerings from a plurality of potential sellers, the offer data including seller identification data and offering identification data. A registry associated with at least one registry owner is provided, with the registry including registry owner data, registry user data and a registry offerings list including offering identification data associated with offerings selected by the registry. Access to the registry's offerings list is provided to a plurality of registry users on the registry users list. Bid data from one of the registry users on a particular offering on the registry's offerings list is then received.

### FIELD

The present application relates generally to the field network data communications. More particularly, the invention relates to an on-line auction within a network-based commerce with respect to offerings on a registry.

### BACKGROUND

Gift registries or wish lists are used whenever a person wants to indicate his or her preference of potential gifts to friends and family members. In particular, wedding registries have been in use for a number of years, where on-line wedding services provides retail store fronts from which the betrothed couple can select preferred gifts. Friends and family members can then access the registry to peruse and purchase any of the preferred gifts.

Registries or wish lists are also developed for other occasions, such as birthdays, the expected birth of a baby, anniversaries and other celebratory occasions.

### SUMMARY OF THE INVENTION

According to one example embodiment, there is provided a system for conducting an on-line auction within a network-based commerce with respect to offerings on a registry, the system including:
a listing creation application module to receive from a plurality of potential sellers offer data pertaining to offerings, the offer data including seller identification data and offering identification data;
a registry applications module to create a registry associated with a registry owner, the registry including registry owner data received from the registry owner, registry user data defining a list of registry users and a registry
offerings list including offering identification data associated with offerings selected by the registry owner; and
an auction application module to
   provide access to the registry's offerings list to a plurality of registry users on the registry users list; and
   receive bid data from one of the registry users on a particular offering on the registry offerings list, the bid data including the registry owner data, the particular offering identification data, registry user identification data and a bid amount.

According to a further example embodiment, there is provided method of conducting an on-line auction within a network-based commerce with respect to offerings on a registry, the method including:
receiving offer data pertaining to offerings from a plurality of potential sellers, the offer data including seller identification data and offering identification data;
providing a registry associated with at least one registry owner, the registry including registry owner data received from the registry owner, registry user data defining a list of registry users and a registry offerings list including offering identification data associated with offerings selected by the registry owner and;
providing access to the registry's offerings list to a plurality of registry users on the registry users list; and
receiving bid data from one of the registry users on a particular offering on the registry's offerings list, the bid data including registry owner data, the particular offerings identification data, registry user identification data and a bid amount.

Other features of the present invention will be apparent from the accompanying drawings and from the detailed description that follows.

### BRIEF DESCRIPTION OF THE DRAWINGS

Embodiments of the present invention is illustrated by way of example and not limitation in the figures of the accompanying drawings, in which like references indicate similar elements and in which:

FIG. 1 is a is a network diagram depicting a system, according to one example embodiment of the present invention;

FIG. 2 is a block diagram illustrating multiple commerce and payment applications;

FIG. 3 is a block diagram illustrating the registry applications;

FIG. 4 is a high-level entity-relationship diagram;

FIG. 5 is a block diagram illustrating the data architecture of information stored in memory according to the example embodiment;

FIG. 6 is a high-level flowchart of a method of conducting an on-line auction within a network-based commerce with respect to offerings on a registry according to an example embodiment of the present invention;

FIG. 7 is a detailed flowchart of the method illustrated by the flow diagram of FIG. 6; and

FIG. 8 is a block diagram showing a machine for performing any one of the example methods described herein.

### DETAILED DESCRIPTION

A method and system to conduct an on-line auction within a network-based commerce system with respect to offerings on a registry are described. In the following description, for purposes of explanation, numerous specific details are set forth in order to provide a thorough understanding of the present invention. It will be evident, however, to one skilled in the art that the present invention may be practiced without these specific details. In the description, offerings include both goods and services offered in a network-based commerce system and/or e-commerce environment.

Platform Architecture

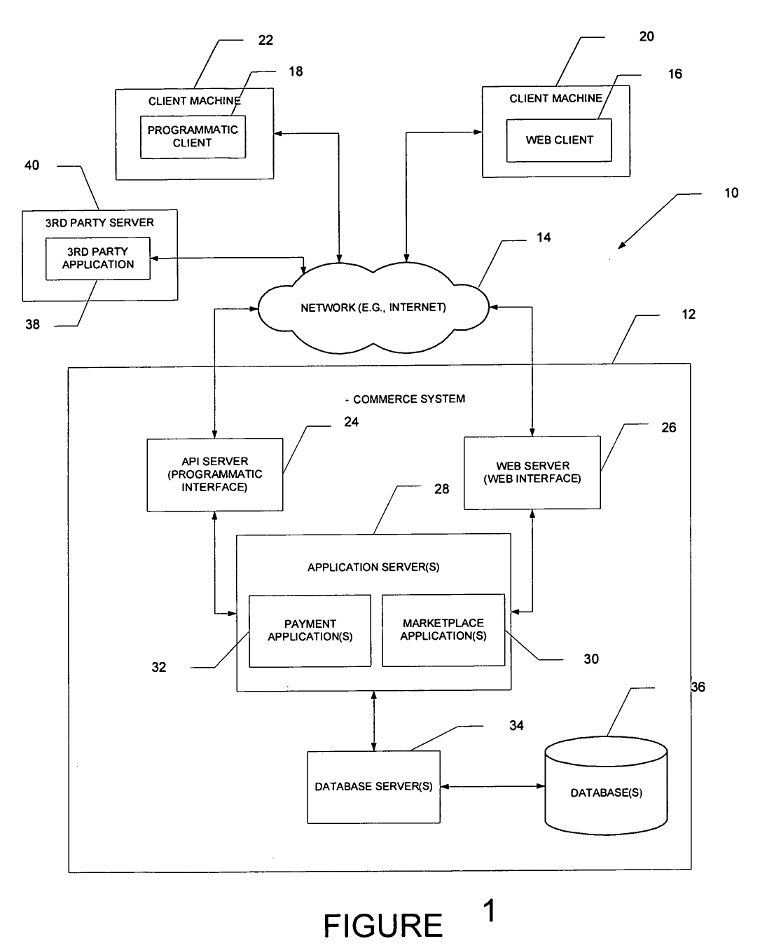

FIG. 1 is a network diagram depicting a system 10, according to one example embodiment of the present invention, having a client-server architecture. A network-based commerce system 12 (e.g., a network-based commerce facilitating multi-seller to multi-buyer trading) provides server-side functionality, via a network 14 (e.g., the Internet) to one or more clients. FIG. 1 illustrates, for example, a web client 16 (e.g., a browser, such as the Internet Explorer browser developed by Microsoft Corporation of Redmond, Washington State or the FireFox browser of the Mozilla Organization), and a programmatic client 18 executing on respective client machines 20 and 22. Each of the clients 16 or 18 may further include (or provide access to) communications applications (e.g., an email, instant message, text chat or Voice over IP (VoIP) application) so as to allow users of the commerce to communicate.

Turning specifically to the network-based commerce system 12, an Application Program Interface (API) server 24 and a web server 26 are coupled, and provide programmatic and web interfaces respectively, to one or more application servers 28. The application servers 28 host one or more commerce applications 30 and payment applications 32. The application servers 28 are, in turn, shown to be coupled to one or more databases servers 34 that facilitate access to one or more databases 36.

The commerce (e.g., marketplace) applications 30 provide a number of commerce functions and services to users that access the commerce system 12. The payment applications 32 likewise provide a number of payment services and functions to users. The payment applications 30 may allow users to quantify for, and accumulate, value (e.g., in a commercial currency, such as the U.S. dollar, or a proprietary currency, such as “points”) in accounts, and then later to redeem the accumulated value for products (e.g., goods or services) that are made available via the commerce applications 30. While the commerce and payment applications 30 and 32 are shown in FIG. 1 to both form part of the network-based commerce system 12, it will be appreciated that, in alternative embodiments of the present invention, the payment applications 32 may form part of a payment service that is separate and distinct from the commerce system 12.

Further, while the system 10 shown in FIG. 1 employs a client-server architecture, the present invention is of course not limited to such an architecture, and could equally well find application in a distributed, or peer-to-peer, architecture system. The various commerce and payment applications 30 and 32 could also be implemented as standalone software programs, which do not necessarily have networking capabilities.

The web client 16, it will be appreciated, accesses the various commerce and payment applications 30 and 32 via the web interface supported by the web server 26. Similarly, the programmatic client 18 accesses the various services and functions provided by the commerce and payment applications 30 and 32 via the programmatic interface provided by the API server 24. The programmatic client 18 may, for example, be a seller application (e.g., the TurboLister application developed by eBay Inc., of San Jose, Calif.) to enable sellers to author and manage listings on the commerce system 12 in an off-line manner, and to perform batch-mode communications between the programmatic client 18 and the network-based commerce system 12.

FIG. 1 also illustrates a third party application 38, executing on a third party server machine 40, as having programmatic access to the network-based commerce system 12 via the programmatic interface provided by the API server 24. For example, the third party application 38 may, utilizing information retrieved from the network-based commerce system 12, support one or more features or functions on a website hosted by the third party. The third party website may, for example, provide one or more promotional, commerce or payment functions that are supported by the relevant applications of the network-based commerce system 12.

Commerce Applications

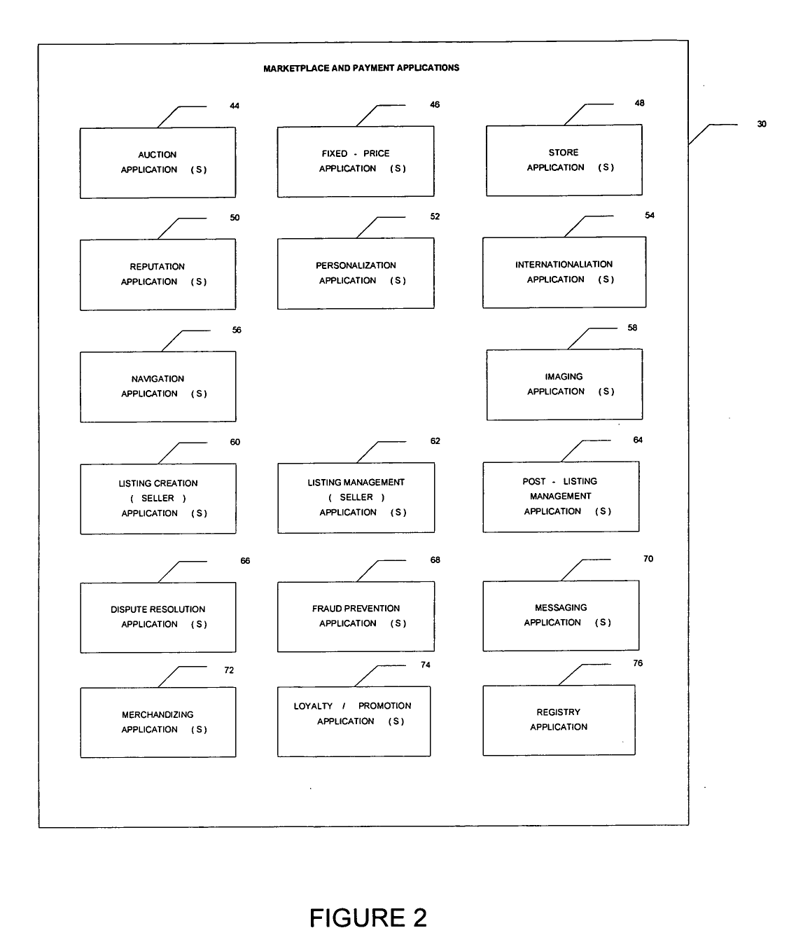

FIG. 2 is a block diagram illustrating multiple commerce and payment applications 30 and 32 that, in one example embodiment of the present invention, are provided as part of the network-based commerce system 12. The commerce system 12 may provide a number of listing and price-setting mechanisms whereby a seller may list offerings, e.g., goods or services, for sale, a buyer can express interest in or indicate a desire to purchase such goods or services, and a price can be set for a transaction pertaining to the goods or services. To this end, the commerce applications 30 are shown to include one or more auction applications 44 which support auction-format listing and price setting mechanisms (e.g., English, Dutch, Vickrey, Chinese, Double, Reverse auctions etc.). The various auction applications 44 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 46 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with an auction-format listing, and allow a buyer to purchase goods or services, which are also being offered for sale via an auction, for a fixed-price that is typically higher than the starting price of the auction.

Store applications 48 allow sellers to group their listings within a “virtual” store, which may be branded and otherwise personalized by and for the sellers. Such a virtual store may also offer promotions, incentives and features that are specific and personalized to a relevant seller.

Reputation applications 50 allow parties that transact utilizing the network-based commerce system 12 to establish, build and maintain reputations, which may be made available and published to potential trading partners. Consider that where, for example, the network-based commerce system 12 supports person-to-person trading, users may have no history or other reference information whereby the trustworthiness and credibility of potential trading partners may be assessed. The reputation applications 50 allow a user, for example through feedback provided by other transaction partners, to establish a reputation within the network-based commerce system 12 over time. Other potential trading partners may then reference such a reputation for the purposes of assessing credibility and trustworthiness.

Personalization applications 52 allow users of the commerce system 12 to personalize various aspects of their interactions with the commerce system 12. For example a user may, utilizing an appropriate personalization application 52, create a personalized reference page at which information regarding transactions to which the user is (or has been) a party may be viewed. Further, a personalization application 52 may enable a user to personalize listings and other aspects of their interactions with the commerce system 12 and other parties.

In one embodiment, the network-based commerce system 12 may support a number of commerce systems that are customized, for example, for specific geographic regions. A version of the commerce system 12 may be customized for the United Kingdom, whereas another version of the commerce system 12 may be customized for the United States. Each of these versions may operate as an independent commerce, or may be customized (or internationalized) presentations of a common underlying commerce.

Navigation of the network-based commerce system 12 may be facilitated by one or more navigation applications 56. For example, a search application enables key word searches of listings published via the commerce system 12. A browse application allows users to browse various category, catalogue, or inventory data structures according to which listings may be classified within the commerce system 12. Various other navigation applications may be provided to supplement the search and browsing applications.

In order to make listings, available via the network-based commerce system 12, as visually informing and attractive as possible, the commerce applications 30 may include one or more imaging applications 58 utilizing which users may upload images for inclusion within listings. An imaging application 58 also operates to incorporate images within viewed listings. The imaging applications 58 may also support one or more promotional features, such as image galleries that are presented to potential buyers. For example, sellers may pay an additional fee to have an image included within a gallery of images for promoted items.

Listing creation applications 60 allow sellers conveniently to author listings pertaining to goods or services that they wish to transact via the commerce system 12. Typically, the listing creation applications receive from a plurality of potential sellers offer data pertaining to offerings. The listing management applications 62 allow sellers to manage such listings. Specifically, where a particular seller has authored and/or published a large number of listings, the management of such listings may present a challenge. The listing management applications 62 provide a number of features (e.g., auto-relisting, inventory level monitors, etc.) to assist the seller in managing such listings. One or more post-listing management applications 64 also assist sellers with a number of activities that typically occur post-listing. For example, upon completion of an auction facilitated by one or more auction applications 44, a seller may wish to leave feedback regarding a particular buyer. To this end, a post-listing management application 64 may provide an interface to one or more reputation applications 50, so as to allow the seller conveniently to provide feedback regarding multiple buyers to the reputation applications 50.

Dispute resolution applications 66 provide mechanisms whereby disputes arising between transacting parties may be resolved. For example, the dispute resolution applications 66 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 68 implement various fraud detection and prevention mechanisms to reduce the occurrence of fraud within the commerce system 12.

Messaging applications 70 are responsible for the generation and delivery of messages to users of the network-based commerce system 12, such messages for example advising users regarding the status of listings at the commerce system 12 (e.g., providing “outbid” notices to bidders during an auction process or to provide promotional and merchandising information to users).

Merchandising applications 72 support various merchandising functions that are made available to sellers to enable sellers to increase sales via the commerce system 12. The merchandising applications 80 also operate the various merchandising features that may be invoked by sellers, and may monitor and track the success of merchandising strategies employed by sellers.

The network-based commerce system 12 itself, or one or more parties that transact via the commerce system 12, may operate loyalty programs that are supported by one or more loyalty/promotions applications 74. For example, a buyer may earn loyalty or promotions points for each transaction established and/or concluded with a particular seller, and be offered a reward for which accumulated loyalty points can be redeemed.

Registry applications 76 create a registry associated with a particular registry owner. A registry owner is a user of the commerce system 12, but not necessarily a buyer or a seller. Registries may typically be a gift registry, such as a wedding registry, or a wish list. The registry applications 76 are responsible for receiving registry owner data, registry user data which forms a registry users list and a registry offerings list which includes offering identification data associated with goods and services selected by the registry owner.

The auction applications 44 provide access to a registry's offerings list to a plurality of registry users on the registry users list. Further to features of supporting auction-format listing and price setting mechanisms, the applications 44 receive bid data from one of the registry users on particular offerings on a registry offerings list and also receive or generate acceptance data accepting or rewarding received bid data on particular offerings.

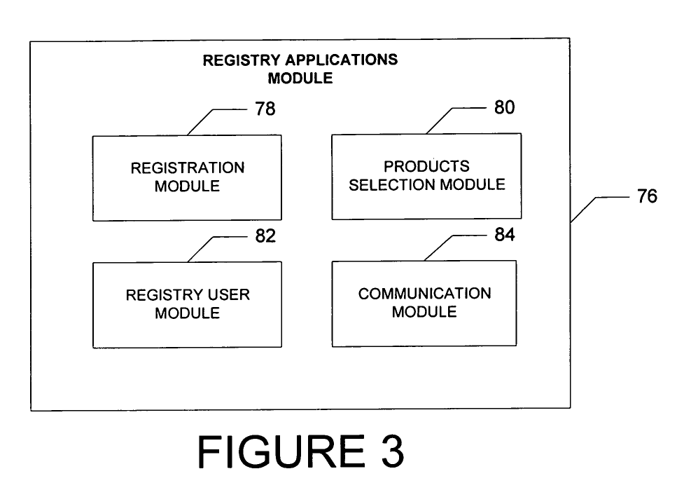

FIG. 3 shows a block diagram of the owner registration module 78, the offerings selection module 80, the user creation and registration module 82 and the communication module 84 that forms part of the registry applications 76. The owner registration module 78 receives registry user data from a user. This registry user data may include registry user identification, address information and financial instrument information. In the event that the user has already registered as a buyer or seller, this information may be provided by other applications within the commerce and payment application. Other information may include event data, which identifies the event associated with the registry, e.g. wedding or birthday details. Shipping data may also be received by the owner registration module 78.

The offerings selection module 80 receives information from a registered registry owner on the different offerings, i.e. goods or services that should form part of the registry's offerings list. The offerings selection module 80 interfaces with the listing creation applications 60, the store applications 48 and the navigation applications 56, and provides the registry owner with different tools to select goods and services for the offerings list of the user's registry.

Users may register themselves as a user of a particular registry or a registry owner may create a list of registry users by making use of the user creation and registration module 82. The user creation and registration module 82 receives registry user information from a registry owner or other users, typically buyers, of the commerce system 12. The registry user data typically includes identification information, address information and financial instrument information. In the event that the potential registry user has already been registered as a buyer, seller or other type of user, this information may be provided by other applications within the commerce and payment application.

The communication module 84 is used to notify the registry owner of acceptance data that has been received or generated accepting or rewarding received bid data on particular offerings. The communication module 84 may also be used to provide a registry user with a registry owner's shipping data. It will be appreciated that the messaging applications 70 of the commerce and payment applications 30 may be the communication module 84 of the registry applications 76. Alternatively, the communication module 84 may interface with the messaging applications 70.

The registry applications 76 allow registry owners to group the offerings selected by them through the offerings selection module 70 within a “virtual” registry. This virtual registry may be personalized by and for the registry owner. Such a virtual registry may provide personal information on the registry owner, event data and specific preferences of the registry owner.

Data Structures

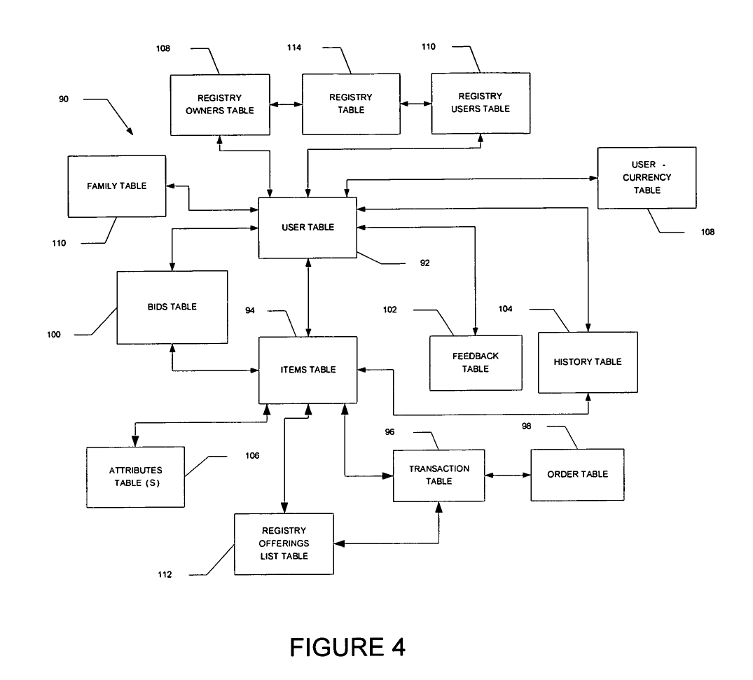

FIG. 4 is a high-level entity-relationship diagram, illustrating various tables 90 that may be maintained within the databases 36, and that are utilized by and support the commerce and payment applications 30 and 32. A user table 92 contains a record for each registered user of the network-based commerce system 12, and may include identifier, address and financial instrument information pertaining to each such registered user. A user may, it will be appreciated, operate as a seller, a buyer, or both, within the network-based commerce system 12. In one example embodiment of the present invention, a buyer may be a user that has accumulated value (e.g., commercial or proprietary currency), and is then able to exchange the accumulated value for items that are offered for sale by the network-based commerce system 12. In addition, and/or in the alternative, a user may also be a registry owner, a registry user or both. It will be appreciated that a registry user will typically first register as a buyer and then as a register user, or alternatively, this registration may be done together. As will be described later, separate tables may be maintained for registries and their owners and users.

The tables 90 also include an items table 94 in which are maintained item records for offerings, i.e. goods and services that are available to be, or have been, transacted via the commerce system 12. Each item record within the items table 94 may furthermore be linked to one or more user records within the user table 92, so as to associate a seller and one or more actual or potential buyers with each item record. Each item record includes offer data which includes seller identification data (linked or obtained from the user table 92) and offering identification data that provides detailed information on each offering. For example, a description of the goods and service may be provided, together with a photograph or other information relating to the offering.

A transaction table 96 contains a record for each transaction (e.g., a purchase transaction) pertaining to items for which records exist within the items table 94.

An order table 98 is populated with order records, each order record being associated with an order. Each order, in turn, may be with respect to one or more transactions for which records exist within the transactions table 96.

Bid records within a bids table 100 each relate to a bid received at the network-based commerce system 12 in connection with an auction-format listing supported by an auction application 44. Bid data typically includes offerings identification data, which may be obtained from or linked to the items table 94. Bid data also includes a bid amount. In instances where a potential buyer is a registered registry user, bid data also includes registry owner data and registry user identification data. A feedback table 102 is utilized by one or more reputation applications 50, in one example embodiment, to construct and maintain reputation information concerning users. A history table 104 maintains a history of transactions to which a user has been a party. One or more attributes tables 106 record attribute information pertaining to items for which records exist within the items table 94. Considering only a single example of such an attribute, the attributes tables 106 may indicate a currency attribute associated with a particular item, the currency attribute identifying the currency of a price for the relevant item as specified in by a seller.

The registry owner table 108 is populated with registry owner records, each registry owner record associated with a specific registered registry owner. Where registry owners are also registered as buyers or sellers, the user record of such buyer or seller in the user table 92 is linked to the associated registry owner record in the registry owner table 108.

Similarly the registry user table 110 is populated with registry users records, each registry user record associated with a specific registered registry user. As a registry user also has to be a registered as a buyer, the user record in the user table 92 is linked to the associated registry user record in the registry owner table 108.

The tables 90 also include a registry offerings list table 112 that is populated by the respective offerings selected by a registry owner. The registry offerings list table 112 is linked to the items table 94, as all offerings in a specific registry offerings list record are selected by a registry owner, from the available items in items table 94. Each record in the registry offerings list table 112 is associated with a particular registry owner record in the registry owner table 108.

A registry table 114 tracks operations on the registry owners table 108, registry users table 110 and registry offerings list table 112.

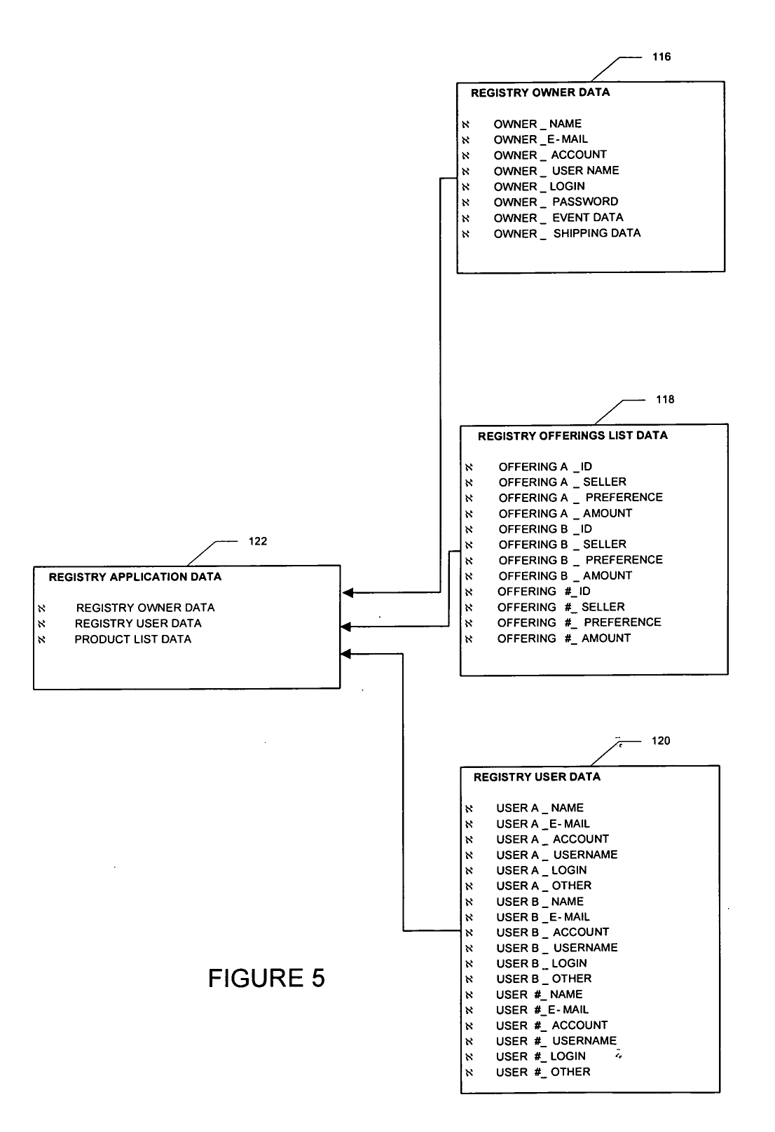

FIG. 5 provides further details regarding pertinent tables that are shown in FIG. 4 to be maintained within the databases 36.

Each registry owner record in the registry owner table 108 contains registry owner data in the form of owner identification data, address data and financial instrument data. Typically owner identification data includes the name and surname of the owner, a username to be used within the commerce system 12, a login which would typically be the username and a password to be used to access the commerce system 12 and/or the specific registry within the commerce system 12. The address data includes a physical address for the registry owner, contact details such as a telephone number, an e-mail address and shipping data for the shipping and delivery of offerings to the registry owner. Financial instrument data may include credit card details, other payment details (e.g. PayPal) or other banking details. As a registry owner would not necessarily purchase items through the commerce system 12, financial instrument data is optional. Registry owner data may further include event data that relates to the specific event associated with the registry. For example, for wedding information on the date of the wedding, the venue, photographs or personal information on the wedding couple may be included. Personal preferences of the registry owner may also form part of the registry owner data.

The registry user data 120 contained in each registry user record in the registry user table 110 includes registry user data such as identification data, address data and financial instrument data. Typically user identification data includes the name and surname of the registry user, a username to be used within the commerce system 12, a login which would typically be the username and a password to be used to access the commerce system 12 and/or the specific registry within the commerce system 12. The address data includes a physical address for the registry owner, contact details such as a telephone number and an e-mail address. Financial instrument data may include credit card details, other payment details (e.g., PayPal) or other banking details. Registry user records may be created by a registry owner, in which case the registry owner may provide limited information on the registry user. For example, the registry owner may only be able to provide the registry users name and surname, a username, login and password. Other information may be provided by the registry user when first accessing the registry. In circumstances where a user of the commerce system 12 has already registered as a buyer, the associated user information may be linked to the registry user record.

Each of the registry offerings list records contains data 118 on the goods and services selected by a particular registry user via the registry offerings selection module 80. This registry offerings list data 118 includes offerings identification, seller information on the particular offering (typically associated with the data in the items table) and preference indication data relating to the particular offering, as assigned by the registry owner. Any fixed price or starting price associated with the offering will also be included as a data item.

Registry data 122 in the registry table 114 includes registry owner data, registry user data and registry offerings list data.

Flowcharts

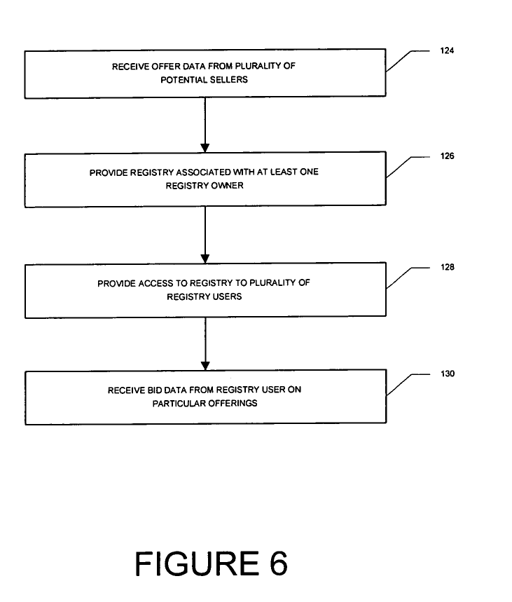

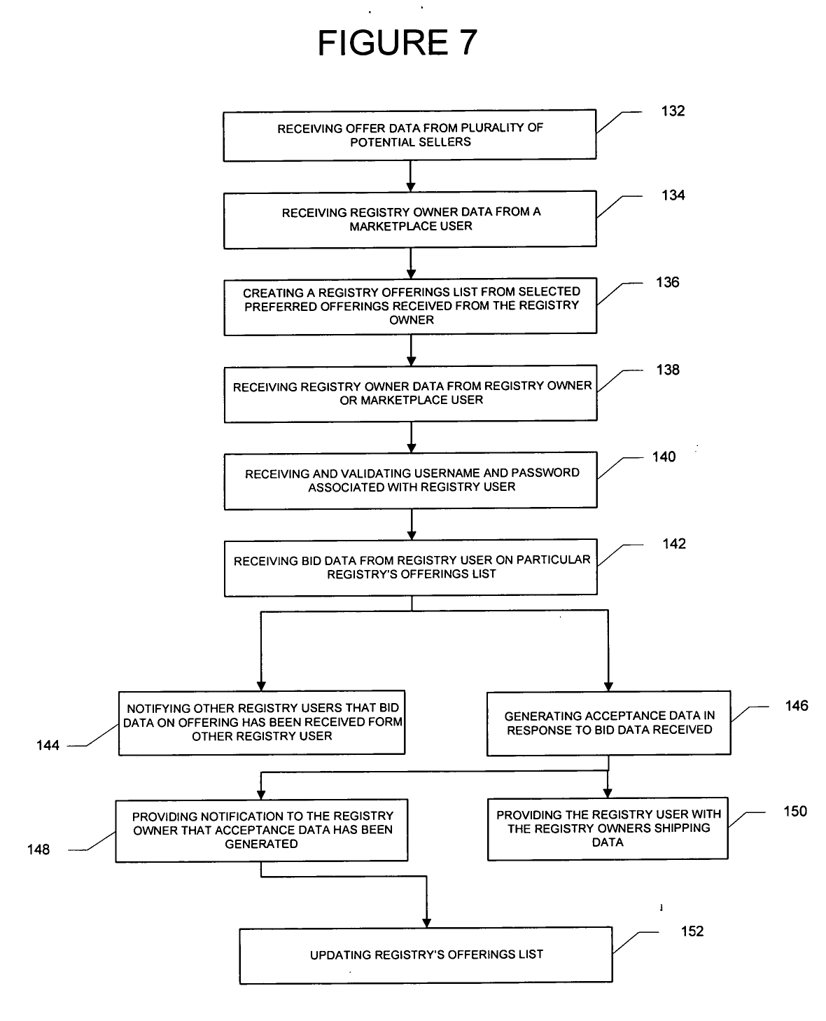

A method of conducting an on-line auction within a network-based commerce system 12 with respect to offerings on a registry is described below according to the high-level flowchart of FIG. 6 and detailed flowchart of FIG. 7.

In operation 124, offer data is received by a listing creation applications module 60. The offer data pertains to offerings from a plurality of potential sellers. As mentioned above, offer data includes seller identification data and offering identification data.

A registry associated with at least one registry owner is provided by the registry application module 76 in operation 126. The registry includes registry owner data received from the registry owner, registry user data defining a list of registry users and a registry offerings list including offering identification data associated with offerings selected by the registry owner.

As shown in operation 128, access to the registry's offerings list is provided by the auction applications module 44 to a plurality of registry users associated with the particular registry owner.

In operation 130, the auction applications module 44 receives bid data from one of the registry users on a particular offering on the registry's offering list. As mentioned above, the bid data includes registry owner data, the particular offering identification data, registry user identification data and a bid amount.

Turning now to FIG. 7, the operations mentioned above will be expanded on and the method of the example embodiment of the invention will be described in more detail.

In operation 132, as described in FIG. 6, offer data is received by a listing creation applications module 60. The offer data is typically received via the web interface supported by the web server 26. The offer data pertains to offerings from a plurality of potential sellers.

The operation of providing a registry associated with at least one registry owner includes receiving registry owner data in operation 134 from a user. In operation 136, a registry offerings list is created by receiving selection preferred offerings from the registry owner via the web interface. The offerings selection module 80 receives information from a registered registry owner on the different offerings, e.g. goods or services, which should form part of the registry's offerings list. As described above, the offerings selection module 80 interfaces with the listing creation applications 60, the store applications 48 and the navigation applications 56, and provides the registry owner with different tools to select goods and services for the offerings list of the user's registry.

Registry user data is received in operation 138 from either a registry owner or from a commerce user, such as a buyer that has an association with the registry user. This data will also be received via the web interface, supported by the web server 26. The registry user data is associated with a particular registry and its owner.

Access to the registry is provided to a plurality of registry users by receiving and validating a username and password from a registry user (operation 140). A user will typically be prompted to enter the username and password on the web interface. Should the username and password correspond and be validated to the username and password of the registered registry user on the registry, access is provided to the registry user.

In operation 142 the auction applications module 44 receives bid data from one of the registry users on a particular offering on the registry's offering list. As mentioned above, the bid data includes registry owner data, the particular offering identification data, registry user identification data and a bid amount. It will be appreciated that bid data will also be received from buyers who are not registered registry users. This is as a particular offering on a registry's offering list is also an offering in the items table, therefore being open to any buyer in the commerce system 12.

As soon as bid data is received from one of the registry users, other registry users on the registry users list are notified that bid data on the particular offering on the registry offerings list has been received from a registry user (operation 144). This is to avoid or at least warn different registry users associated with one registry from bidding against each other for the same offering.

Acceptance data is generated by the auction applications module 44 in operation 146. This generation of acceptance data is either in response to the acceptance of bid data from a potential seller on a particular offering, or may alternatively be generated automatically by the auction applications module 44 at the end of a predetermined time period, or according to predetermined rules.

Once the acceptance data has been generated, the different applications of the commerce system 12, in particular the payment applications will perform their different functions in order to finalize the purchase transaction and to record the transaction in the transaction table 96. In particular, the communications module 84 of the registry applications module, will provide the registry owner with a notification that acceptance data has been generated on the particular offerings on the registry offerings list (operation 148), thereby confirming that a purchase transaction has been completed for the particular offering on the offerings list. Such notification may be at least one of a group of messages, including an e-mail message, an SMS message, an IM message and a voice message. This message is sent so that the registry owner does not add an offering for a similar product to the registry, without knowing that a purchase has been made.

Also after the generation of the acceptance data, the communications module 84 of the auction applications module 76 provides the registry user with the registry owners shipping data in operation 150. This information may be provided by the commerce system 12 by populating a particular field during the purchase transaction with the shipping details and address. Alternatively, the communications module 84 may send a notification message similar to the message sent to the registry owner. By providing the shipping address of the registry owner to the registry user, the registry user would be able to ship the offering as a gift directly to the registry owner.

In operation 152 the registry offerings list of the specific registry will be updated to indicate that the particular offering has already been purchased. This will ensure that registry users do not buy similar or the same goods and services. It will also allow the registry owner of having up to date data on the status of the registry. Where the offering comprises of a number of offerings, the amount of offerings still on the registry offerings list will be updated.

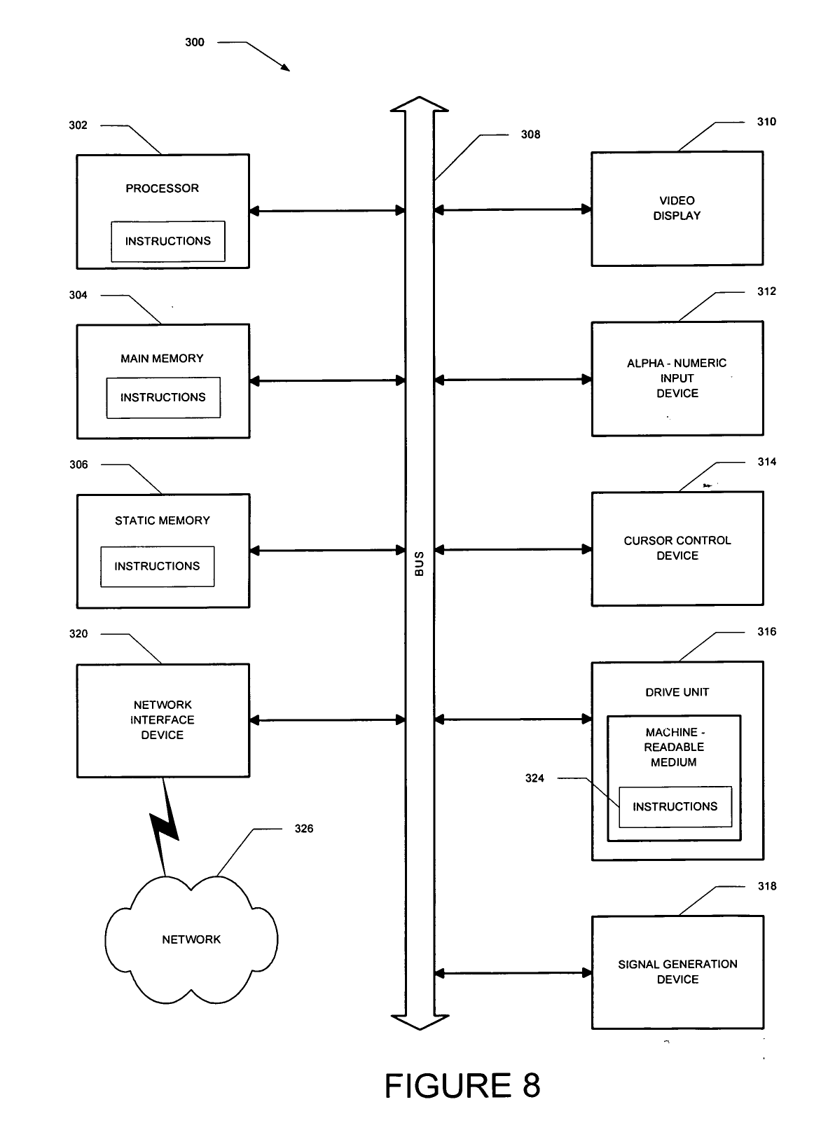

FIG. 8 shows a diagrammatic representation of machine in the example form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to conduct an on-line auction within a network-based commerce with respect to offerings on a registry have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A system for conducting an on-line auction within a network-based commerce system with respect to offerings on a registry, the system including:
a listing creation application module to receive from a plurality of potential sellers offer data pertaining to offerings, the offer data including seller identification data and offering identification data;
a registry applications module to create a registry associated with a registry owner, the registry including registry owner data received from the registry owner, registry user data defining a list of registry users and a registry offerings list including offering identification data associated with offerings selected by the registry owner; and
an auction application module to
provide access to the registry's offerings list to a plurality of registry users on the registry users list; and
receive bid data from one of the registry users on a particular offering on the registry offerings list, the bid data including the registry owner data, the particular offering identification data, registry user identification data and a bid amount.

2. The system of claim 1 wherein the auction application module generates acceptance data accepting the received bid data on the particular offerings.

3. The system of claim 2 wherein the acceptance data is generated in response to the acceptance of bid data from the potential seller on the particular offering, or alternatively generated automatically at the end of a predetermined time period, or according to predetermined rules.

4. The system of claim 1 wherein the registry applications module includes an owner registration module to receive from the registry owner registry owner data.

5. The system of claim 1 wherein the registry applications module includes an offerings selection module to receive from the registry owner selected offering identification data associated with offerings for defining the registry offerings list.

6. The system of claim 1 wherein the registry applications module includes a registry user creation and registration module to receive either from the registry owner or from users of the commerce system associated with the registry owner, registry user data.

7. The system of claim 1 wherein the registry applications module includes a communication module to notify the registry owner that acceptance data has been received on particular offerings on the registry's offerings list.

8. The system of claim 1 wherein the registry owner data includes or accesses shipping data for the registry owner.

9. The system of claim 2 wherein, on generation of the acceptance data by the auction applications module, the communication module provides the registry user with the registry owner's shipping data.

10. The system of claim 1 wherein the communication module notifies other registry users on the registry users list that bid data on the particular offerings on the registry's offerings list has been received from a registry user.

11. A method of conducting an on-line auction within a network-based commerce system with respect to offerings on a registry, the method including:
receiving offer data pertaining to offerings from a plurality of potential sellers, the offer data including seller identification data and offering identification data;
providing a registry associated with at least one registry owner, the registry including registry owner data received from the registry owner, registry user data defining a list of registry users and a registry offerings list including offering identification data associated with offerings selected by the registry owner and;
providing access to the registry's offerings list to a plurality of registry users on the registry users list; and
receiving bid data from one of the registry users on a particular offering on the registry's offerings list, the bid data including registry owner data, the particular offerings identification data, registry user identification data and a bid amount.

12. A method according to claim 11 wherein auction acceptance data accepting the received bid data on the particular offerings is generated.

13. A method according to claim 12 wherein the acceptance data is generated in response to the acceptance of bid data from the potential seller on the particular offering, or alternatively generated automatically at the end of a predetermined time period, or according to predetermined rules.

14. A method according to claim 11 wherein providing a registry associated with at least one registry owner includes receiving registry owner data from a commerce system user, creating a registry offerings list by receiving selection preferred offerings from the registry owner and receiving registry user data from either a registry owner or from a commerce system user.

15. A method according to claim 11 wherein providing access to the registry's offerings list by receiving a username and password from a registry user and corresponding the username and password with information on the registry users list.

16. The method of claim 11 further including providing the registry owner with a notification that acceptance data has been received on the particular offerings on the registry's offerings list.

17. The method of claim 16 wherein the notification is at least one of a group of messages including an e-mail message, an IM message and a voice message.

18. The method of claim 11 wherein the registry owner data includes registry owner shipping data.

19. The method of claim 12 further including, on the generation of the acceptance data, providing the registry user with the registry owner shipping data.

20. The method of claim 11 further including notifying other registry users on the registry users list that bid data on the particular offering on the registry's offerings list has been received from a registry user.

21. The method of claim 11 further including updating the registry offerings list once the acceptance data has been generated.

22. A machine-readable medium comprising instructions, which when executed by a machine, cause the machine to perform the method of claim 6.

23. A system for conducting an on-line auction within a network-based commerce system with respect to offerings on a registry, the system including:
first means for receiving from a plurality of potential sellers offer data pertaining to offerings, the offer data including seller identification data and offering identification data;
second means for creating a registry associated with a registry owner, the registry including registry owner data received from the registry owner, registry user data defining a list of registry users and a registry offerings list including offering identification data associated with offerings selected by the registry owner; and
third means for
providing access to the registry's offerings list to a plurality of registry users on the registry users list; and
receiving bid data from one of the registry users on a particular offering on the registry offerings list, the bid data including the registry owner data, the particular offering identification data, registry user identification data and a bid amount.

24. The system of claim 23 wherein the third means includes fourth means for receiving from the registry owner registry owner data.

25. The system of claim 23 wherein the third means includes fifth means for receiving from the registry owner selected offering identification data associated with offerings for defining the registry offerings list.

26. The system of claim 23 wherein the third means includes sixth means for receiving either from the registry owner or from users of the commerce system associated with the registry owner, registry user data.

27. The system of claim 23 wherein the third means includes seventh means for notifying the registry owner that acceptance data has been received on particular offerings on the registry's offerings list.
